(19) United States
(12) Patent Application Publication
(10) Pub. No.: US 2006/0279541 A1
(43) Pub. Date: Dec. 14, 2006

(54) Apparatus and method for supporting user interface enabling user to select menu having position or direction as corresponding to position or direction selected using remote control

(75) Inventors: Hyun-jin Kim, Gwangju (KR); Ho-joon Yoo, Seoul (KR); Joon-kee Cho, Yongin-si (KR); Soon-joo Kwon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/441,128

(22) Filed: May 26, 2006

(30) Foreign Application Priority Data
Jun. 13, 2005 (KR) 10-2005-0050518

(51) Int. Cl. G09G 5/08

(52) U.S. Cl. 345/158

(57) ABSTRACT

An apparatus and method for providing a user interface that enables a user to select a menu having the same position or direction as a position selected by a remote control. The apparatus includes an interface storing unit which stores items of menus and information about functions provided by the menus, an output unit which outputs items of a first menu stored in the interface storing unit on the circumference of a figure, a receiving unit which receives an input signal from the remote control, and a control unit which, when the input signal received by the receiving unit includes a position selected by the remote control, selects an item of the first menu located at a position of the figure corresponding to the position selected by the remote control and executes a function corresponding to the selected item of the first menu.

### CROSS-REFERENCE TO RELATED APPLICATION

This application claims priority from Korean Patent Application No. 10-2005-0050518 filed on Jun. 13, 2005 in the Korean Intellectual Property Office, the disclosure of which is incorporated herein by reference.

### BACKGROUND OF THE INVENTION

1. Field of the Invention

The present invention relates to a user interface (UI), and more particularly, to an apparatus and method for supporting a UI that enables a user to select a menu having the same position or direction as a position or direction selected using a remote control.

2. Description of Related Art

A user interface (UI) may be referred to as a boundary in user's use of digital products. A user recognizes the function of a product and uses the product through a UI, and the product operates according to a signal or command received through the UI. Thus, a barometer of how usefully the user can use the UI, i.e., “availability”, should be considered in designing of the UI. For availability, ease of use and intuitive use should be considered. Ease of use enables the user to actuate a certain function with minimum inputs or to easily use the function. Ease of use becomes an issue in a digital device using a remote control when a function is performed by inputting a direction using the remote control or a jogshuttle function or many inputs are required. Thus, it is important to provide many functions while reducing the number of inputs.

Intuitive use means that when a function is performed or a result is output in response to a user input, the function or the result meets a user's expectations. For example, when a user presses a left key while viewing a menu, a screen moves to the left or a left item of the menu is selected. When the user selects a function, intuitive use can be improved by providing a function or an output that would be intuitively expected by the user as a result of the selection.

Conventionally, in computer software, a “what you see is what you get (WYSIWYG)” type UI is applied to an editor or an operating system. WYSIWYG is used in MICROSOFT® operating systems, in which overlapping windows are shown to a user, the windows actually overlap as shown to the user, and the user can select a specific item in the windows. WYSIWYG is a UI that has been implemented and developed through a mouse and a keyboard.

Meanwhile, a digital device using a remote control provides a UI that is different to a mouse type UI. Since the remote control generally employs direction input signals for menu selection or function execution, it provides a UI that enables a hierarchical structure. However, the hierarchical structure has a drawback in that the user should make selections in all upper menus of a specific menu in order to select or move to the specific menu.

In WO 03/036642, the result of rotational action of a UI is transformed into a linear form. FIG. 1 is a view showing that an input rotational action vertically moves a menu selection bar on an actual display. A digital device 2 displays a stored music list and reproduces a music file. A user rotates a rotational action input device 1 and a menu selection bar 3 moves vertically according to a user input. However, the direction of a user action is not the same as the direction of movement on a UI corresponding to the user action. Such a difference causes a difficulty in improving intuitive use of the UI.

FIG. 2 illustrates a conventional user interface (UI), as disclosed in U.S. Pat. No. 6,411,337, in which a menu is selected using a wheel-shaped form. When a user generates an input signal for controlling vertical movement using an input device while viewing displayed menu items, the menu items of FIG. 2 move vertically through rotation. However, in this case, when N menu items exist, the user should press a key an average of N/2 times. Such manipulation inconveniences the user when a number of menu items exist.

With the increasing integration of digital devices with one another, the demand for viewing still pictures and moving pictures on a digital TV screen has increased. However, there is a limitation in effecting general UP, DOWN, LEFT, RIGHT, and mode switch navigation schemes using conventional remote controls. As contents to be controlled by a remote control, such as moving pictures, still pictures, and music files, increase and functions become complicated, the number of stages for menu adjustment and content navigation sharply increases. When a downloaded picture is rotated using an interface such as a Sony's cross media bar (XMB) interface, a number of selections should be made such that a picture menu is selected, a download memory is selected, a folder is selected, a target picture is selected through navigation, and an edition menu is selected.

In addition, intuition is degraded due to a discrepancy between a screen and manipulation of a remote control as shown in FIG. 1, and a user should perform an action while viewing a remote control when the arrangement of content/menu items on a screen is different from the arrangement of up/down/left/right navigation buttons and menu buttons. Furthermore, a content appreciation behavior and an actual driving method of content application are not consistent. Moreover, when appreciating contents, a user is likely to desire to view another still picture or moving picture associated with the appreciated contents. However, current navigation methods do not meet such a user's demand.

Therefore, a method for configuring menus for intuitive menu selection and a remote control device using the method are required.

### BRIEF SUMMARY

An aspect of the present invention provides an apparatus and method for supporting a user interface (UI), in which a menu item in a UI displayed on a screen, which has a position or direction corresponding to as a signal transmitted from a remote control, can be selected, thereby improving intuitive use and ease of use.

An aspect of the present invention also provides an apparatus and method for supporting a user interface (UI), in which a specific function can be selected without a number of inputs and screen conversions, thereby enabling rapid manipulation with respect to a digital device.

According to an aspect of the present invention, there is provided an apparatus for providing a user interface that enables a user to select a menu having a position or direction corresponding to a position selected by a remote control, which includes an interface storing unit which stores items of menus and information about functions provided by the menus, an output unit which outputs items from the first menu stored in the interface storing unit on the circumference of a figure, a receiving unit which receives an input signal of a remote control, and a control unit which, when the input signal received by the receiving unit includes a position selected by the remote control, selects an item of the first menu located at a position of the figure corresponding to the position selected by the remote control and executes a function corresponding to the selected item of the first menu.

According to another aspect of the present invention, there is provided a remote control which includes a figure control unit which receives menu position information from outside, a direction control unit which receives up and down or right and left direction information, and a transmitting unit which transmits the received menu position information and direction information to an output device, wherein the received menu position information indicates a position whose input is sensed by the figure control unit, and the transmitting unit transmits the menu position information and executes menu corresponding to the menu position information of an interface output on the output device.

According to still another aspect of the present invention, there is provided a method of providing a user interface that enables a user to select menu having the same position or direction as a position selected by a remote control, which includes outputting items of a first menu on the circumference of a figure, receiving an input signal from the remote control and when the input signal contains a position selected by the remote control, selecting an item of the first menu at a position of the figure corresponding to the position selected by the remote control and executing a function provided by the selected item of the first menu.

According to another aspect of the present invention, there is provided a computer-readable storage medium encoded with processing instructions for causing a processor to execute the aforementioned method.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a view showing that an input rotational action vertically moves a menu selection bar on an actual display, according to conventional art;

FIG. 2 illustrates a conventional user interface (UI);

FIG. 3 illustrates a UI and a remote control according to an embodiment of the present invention;

FIG. 4 illustrates a UI according to an embodiment of the present invention, applied to a digital TV;

FIG. 5, parts (A) and (B), illustrates a direction menu according an embodiment of the present invention;

FIG. 6 illustrates a direction menu according to another embodiment of the present invention;

FIG. 7, parts (A) and (B), illustrates a change in items displayed in a circular menu, by a direction menu according to an embodiment of the present invention;

FIG. 8 is a view showing that figures according to an embodiment of the present invention are not circles;

FIG. 9 is a view showing that a figure menu and a direction menu according to an embodiment of the present invention are separately displayed;

FIG. 10 illustrates arranging of contents of FIG. 4 or 8 to satisfy a UI according to an embodiment of the present invention;

FIG. 11 illustrates a remote control according to an embodiment of the present invention;

FIG. 12 illustrates a remote control including a circular control unit having buttons according to another embodiment of the present invention;

FIG. 13 illustrates a touch panel according to an embodiment of the present invention;

FIG. 14 is a flowchart illustrating a method used by a display device to provide a function corresponding to an input signal of a remote control according to an embodiment of the present invention;

FIG. 15 is a block diagram of a UI output device according to an embodiment of the present invention; and

FIG. 16 is a block diagram of a remote control according to an embodiment of the present invention.

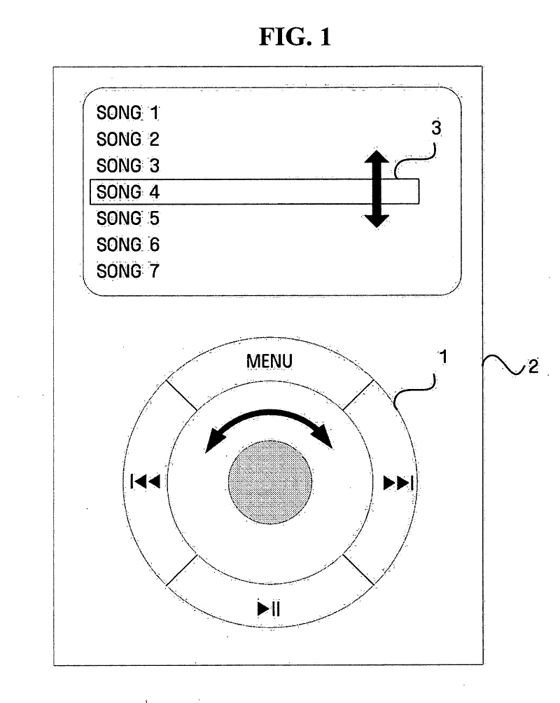

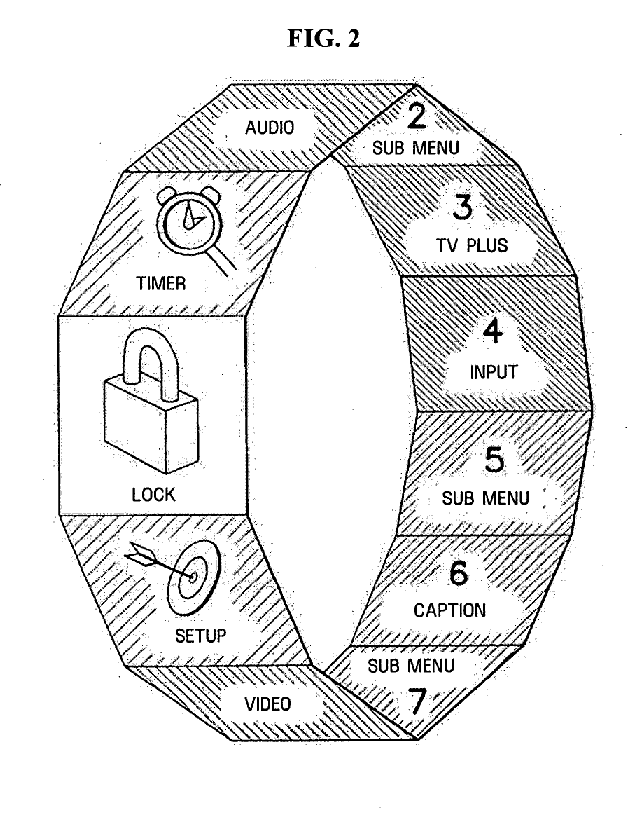

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Embodiments of the present invention are described hereinafter with reference to flowchart illustrations of an apparatus and method for supporting a UI that enables a user to select a menu having the same position or direction as a position or direction selected using a remote control according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

And each block of the flowchart illustrations may represent a module, segment, or portion of code, which comprises one or more executable instructions for implementing the specified logical function(s). It also is to be noted that in some alternative implementations, the functions noted in the blocks may occur in an order that differs from those described hereinafter. For example, two blocks shown in succession may in fact be executed substantially concurrently or the blocks may sometimes be executed in the reverse order, depending upon the functionality involved;

In the embodiments of the present invention described below, a “unit”, “part” or a “module” indicates a software component or a hardware component such as a field-programmable gate array (FPGA) or an application-specific integrated circuit (ASIC). The unit performs a particular function but is not restricted to software and hardware. The unit may be included in an addressable storage medium or may be configured to play one or more processors. Accordingly, units may include components such as software components, object-oriented software components, class components, and task components, processes, functions, attributes, procedures, subroutines, segments of a program code, drivers, firmware, microcodes, circuits, data, databases, data structures, tables, arrays, and parameters. Components and features provided by units may be combined into a smaller number of components and a smaller number of units, or may be divided into a greater number of components and a greater number of units. In addition, components and units may be implemented such that they play one or more central processing units (CPUs) in a device or a secure MMC.

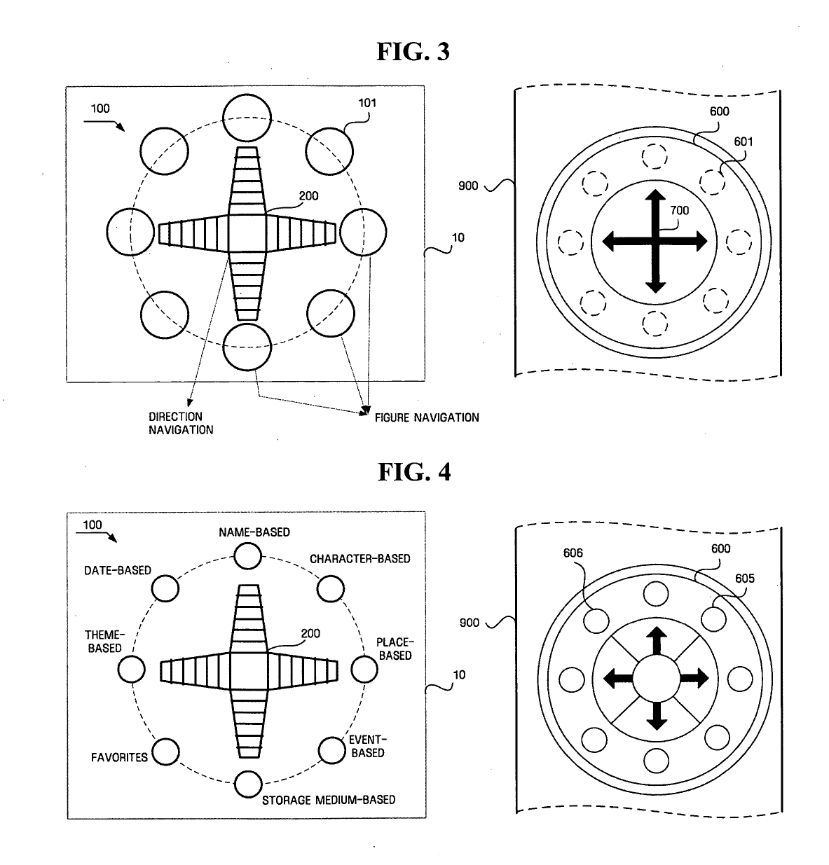

FIG. 3 illustrates a UI and a remote control according to an embodiment of the present invention.

Two types of menus, i.e., a figure menu 101 and a direction menu 200, are displayed on a display screen 10. When one of the figure menu 101 and the direction menu 200 is selected, information of the other menu may be changed. Although the figure menu 101 and the direction menu 200 are used to distinguish the two types of menus in the present embodiment, such a description is only a non-limiting example. In the following description, a circular menu is used as exemplary configuration of the figure menu, but the figure menu may take various forms, such as, by way of non-limiting examples, a square, a triangle, and a hexagon, as such figures can be converted into a circle by connecting their vertices. Thus, a description will be made for a case where the circular menu as one example of figure menu.

Each item of the figure menu occupies a corresponding one of four or eight distinguishable equal parts of a circle. The items of the figure menu are output on the circumference of the circle. Selection with respect to the figure menu 100 can be performed by a circular control unit of a remote control 900. In the following description, the present embodiment is described with regard to a circular control unit as an example of the figure control unit 600. The circular control unit 600 may include a plurality of buttons and may use a touch panel. The configuration of the circular control unit 600 will be described later. The circular control unit 600 is configured so that its buttons intuitively match the figure menu on the display screen 10. For example, to select an element 101, a button 601 or a touch panel of the circular control unit 600 at a position that is similar to or the same as the position of the element 101 is pressed. Selection with respect to the figure menu is performed by the circular control unit 600 and selection with respect to the direction menu 200 is performed by a direction control unit 700. The direction control unit 700 is used to input an up, down, left, or right direction. Here, the direction control unit 700 may be used to input a diagonal direction. In addition, the direction control unit 700 may be implemented to recognize up, down, left, right, and diagonal directions using a touch panel. When a user rubs the direction control unit 700 from top to bottom, a signal corresponding to a down direction is generated.

As can be seen from FIG. 3, two types of menus are displayed on a screen and are controlled in different ways. Thus, much information can be provided and a menu can be selected within a short period of time. In addition, since movement in the screen and manipulation with respect to the screen coincide with each other, the user does not need to view the remote control during manipulation. Once the circular menu (example of figure menu) is displayed on the display screen 10, the user can execute a menu by selecting a button of the circular control unit 600 of the remote control 900 at the same position as the menu item while viewing the display screen 10. In this way, ability to perform intuitive selection and conveniently use a menu can be provided to the user. In addition, a menu having various levels is simultaneously arranged on a single screen and stages of navigation for menu selection are reduced. Associated menus can be shown at a glance.

FIG. 4 illustrates a UI according to an embodiment of the present invention, applied to a digital TV. A menu for appreciating image content is provided on the display screen 10 of a digital TV. The figure menu 100 includes various arrangement items corresponding to different ways of viewing image content. According to a ‘date based’ item, image contents are shown by date at which the image contents are stored or reproduced. According to a ‘name based’ item, the names of image contents are arranged according to a predetermined criterion for appreciation. According to a ‘character based’ item, image contents are arranged by character information of the image contents. According to a ‘place based’ item, image contents are arranged by place where the image contents are created. According to an ‘event based’ item, image contents are arranged by events such as a wedding ceremony, a graduation ceremony, or a birthday party. According to a ‘storage medium based’ item, image contents are arranged by storage media for storing the image contents, e.g., a hard disk of a computer, a compact disc-read only memory (CD-ROM), or a digital versatile disc (DVD) for appreciation for each of the storage media. According to a ‘favorite based’ item, image contents registered by a user in a ‘Favorite’ item are shown. According to a ‘theme based’ method, image contents are arranged by themes of the image contents.

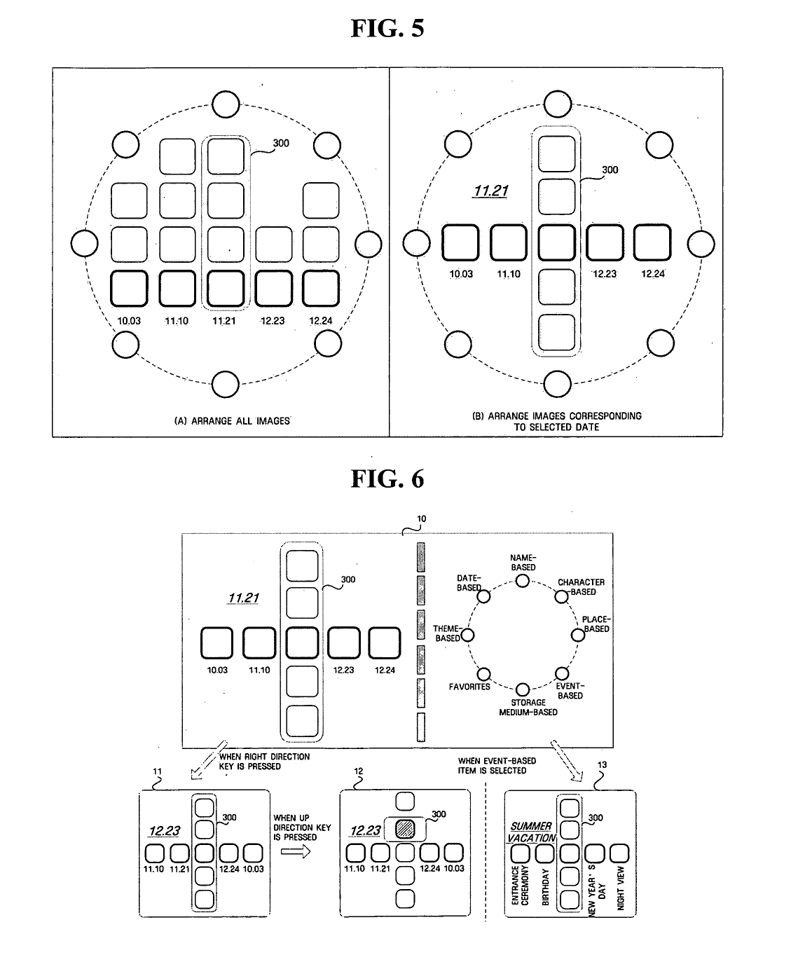

Meanwhile, in the direction menu 200 in the form of a cross in the central position of the display screen 10, contents are arranged according to an arrangement method selected from the figure menu 100. For selection with respect to the figure menu 100, a user selects a position on the circular control unit 600 of the remote control 900 that corresponds to a target position in the figure menu 100. For example, when the user desires to appreciate image content according to characters, the user presses a button 605 or makes a selection through a touch panel. When the user desires to appreciate image content according to dates, the user presses a button 606 or a touch panel. The user can intuitively make a selection with respect to the figure menu 100 using the remote control 900. The user can select a ‘date based’ item by pressing a button 606 or the touch panel of the circular control unit 600 as shown in FIG. 5.

FIG. 5, parts (A) and (B), illustrates a direction menu according an embodiment of the present invention. When the user presses the button 606 for date-based arrangement in FIG. 4, image information is horizontally arranged by date as shown in FIG. 5 and the user can select images using a direction input key. A selection bar 300 marks a currently selected item of the direction menu 200. In the direction menu 200, images may be arranged vertically according to dates and may be displayed to the user as shown in part (A) of FIG. 5 or only images corresponding to a selected date may be displayed to the user as shown in part (B) of FIG. 5. Images corresponding to other dates may be displayed one-by-one for each date and thus form a cross with the images corresponding to the selected date. The arrangement may vary with the type of content or the type of menu to be output. When the user moves the selection bar 300 using a left or right button, images corresponding to a date of an item indicated by the moved selection bar 300 may be arranged. Although the direction menu 200 of FIGS. 3 and 4 is shown within a figure in an embodiment of the present invention, it may be shown outside the figure as will be described later.

FIG. 6 illustrates a direction menu according to another embodiment of the present invention. When date-based arrangement is selected by pressing the button 606 in FIG. 4, data may be displayed within a figure in which the circular menu is arranged as shown in FIG. 5, or may be displayed outside the figure as shown in FIG. 6. To improve a visual effect of the direction menu on which a user's selection is to be made, the figure in which the circular menu is arranged is reduced. The circular menu and the direction menu may be separated and arranged at the left side and the right side, unlike in FIG. 4. The circular menu and the direction menu may be separately arranged or arranged together to improve readability according to the number of items of the circular menu and the direction menu. When the user presses left and right buttons of the remote control 900, the selection bar 300 moves in units of a date as shown in 11. 11 is a portion of the display screen 10 in which the selection bar 300 moves to the right side, i.e., to a ‘12.23’ item through the user's selection of a right direction key. The right direction key means a right direction key among direction keys 700 of the remote control 900 of FIG. 3. The selection bar 300 may move to the right side, but may move to the left side like rotation of the entire menu with respect to the selection bar 300. The selected ‘12.23’ item is arranged at the left side of the figure. To select images stored on December 23, up and down direction keys may be used. As a result, the selection bar 300 may move to one of vertically arranged images as in a portion 12 of the display screen 10.

Meanwhile, another portion 13 of the display screen 10 is displayed when the user selects another item in the circular menu. When the user presses a button or a touch panel of the remote control 900 at a position corresponding to the ‘event based’ item, items of the direction menu are arranged by event. As a result, images corresponding to “Entrance ceremony”, “Birthday”, “Summer vacation”, “New year's day”, and “Night view” are arranged.

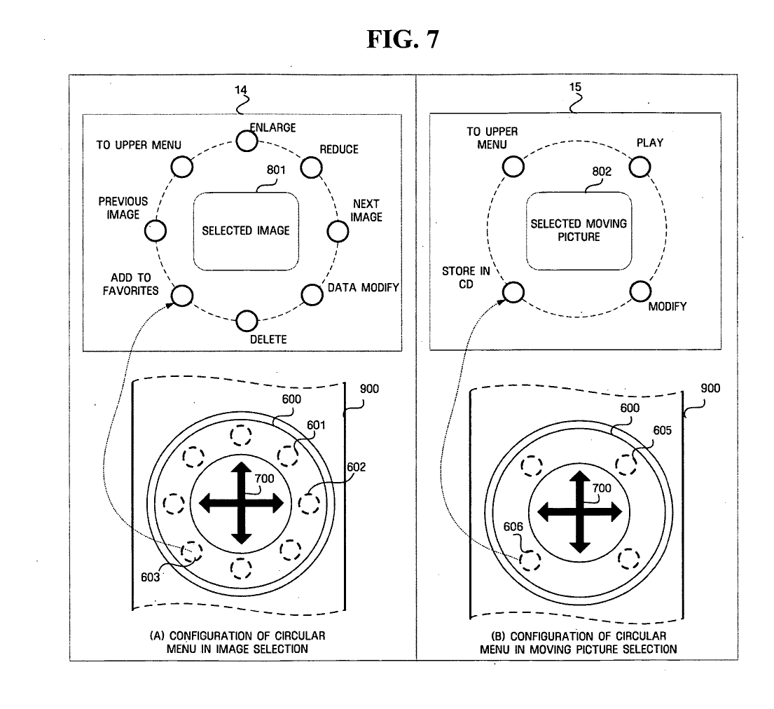

FIG. 7, parts (B) and (B), illustrates a change in items displayed in a circular menu, by a direction menu according to an embodiment of the present invention. Part (A) of FIG. 7 shows a case where one of images arranged in the direction menu is selected inside the circular menu like in FIG. 5. In FIG. 5, the circular menu includes items for enabling the user to select a way to navigate an image. If the user selects one image 801, the selected image 801 is output within the figure and functions required for appreciation of the selected image 801 may be arranged on the circumference of the figure. In part (A) of FIG. 7, functions that can be performed on image content are arranged in the circular menu. The circular menu includes “enlarge”, “reduce”, “next image”, “modify data”, “delete”, “add to favorites”, “previous image”, and “to upper menu” items. The “enlarge” and “reduce” items enlarge or reduce the selected image 801 when corresponding positions of the remote control 900 are pressed. To reduce the selected image 801, a position 601 is pressed. The “previous image” and “next image” items show a previous image and a next image with respect to a selected date. To select the “next image” item, a position 602 is pressed. The “add to favorites”, “delete”, and “modify data” items perform corresponding functions on the selected image 801. The “to upper menu” item displays an upper menu, i.e., parts (A) or (B) of FIG. 5 when images are arranged by date.

Part (B) of FIG. 7 shows the circular menu when the user selects a moving picture 802. Unlike in part (A) of FIG. 7, the circular menu includes “play”, “modify”, “store in CD”, and “to upper menu” items. In this case, only four items are arranged in the figure menu 100, unlike in part (A) of FIG. 7. The user presses a position 605 to reproduce the selected moving picture 802. The remote control 900 may transmit information about a pressed position and information about sensors existing in the pressed position. The direction menu showing contents and the figure menu controlling contents are separately displayed in a single screen and selection can be made by a single input.

As can be seen from parts (A) and (B) of FIG. 7, the circular menu may include various numbers of items.

In the above description, by outputting a first menu on the circumference of a figure and outputting a second menu inside or outside the figure, many screen conversions or inputs to a remote control are not necessary in selection with respect to the two menus. In addition, since items are output on the circumference of the figure and a corresponding item is executed by selecting a position of the remote control corresponding to the item on the circumference of the figure, the user can more intuitively select the item than when the user selects the item by moving a selection bar in a specific direction many times. However, the figure is not necessarily a circle. For example, in part (B) of FIG. 7, the figure is a square. Although a circle is shown in parts (A) and (B) of FIG. 7, a square is formed by connecting selectable items of the circular menu. While the figure menu is referred to as the circular menu for convenience herein, such an indication does not mean that the figure is necessarily a circle. Indeed, other configurations are contemplated.

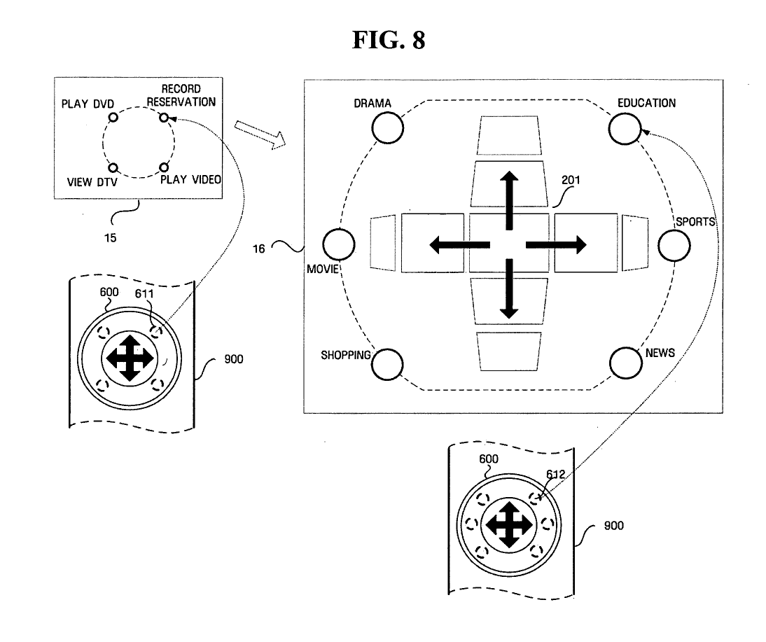

FIG. 8 is a view showing that figures according to an embodiment of the present invention are not circles. When the figure is not a circle, a corresponding item can be selected by pressing a position of the circular control unit of the remote control unit 900. A display screen 15 of FIG. 8 shows four items of the circular menu, i.e., “play DVD”, “reserved recording”, “view DTV”, and “play video” items. In the display screen 15, only the circular menu is shown and another menu is not shown within a figure. By pressing a position 611 of the circular control unit 600 of the remote control 900, the “reserved recording” item is selected. The figure menu provides genre items subject to reserved recording, such as “drama”, “movie”, “shopping”, “education”, “sports”, and “news” items. In a direction menu 201, channels are arranged horizontally and program information of a selected channel is arranged vertically. Here, the user can select channels related to education by pressing a position 612 of the remote control 900. Channels for education are arranged horizontally and programs of a selected channel are arranged vertically. When the remote control 900 is implemented with a touch panel, the user can make an input through downward scrolling. In this case, a selection bar moves in the direction of user's scrolling or a list may move with respect to the selection bar. When a direction control unit is implemented with a touch panel, the user moves his/her finger downwardly while pressing the upper direction of the direction control unit with his/her finger, thereby performing scroll-like movement.

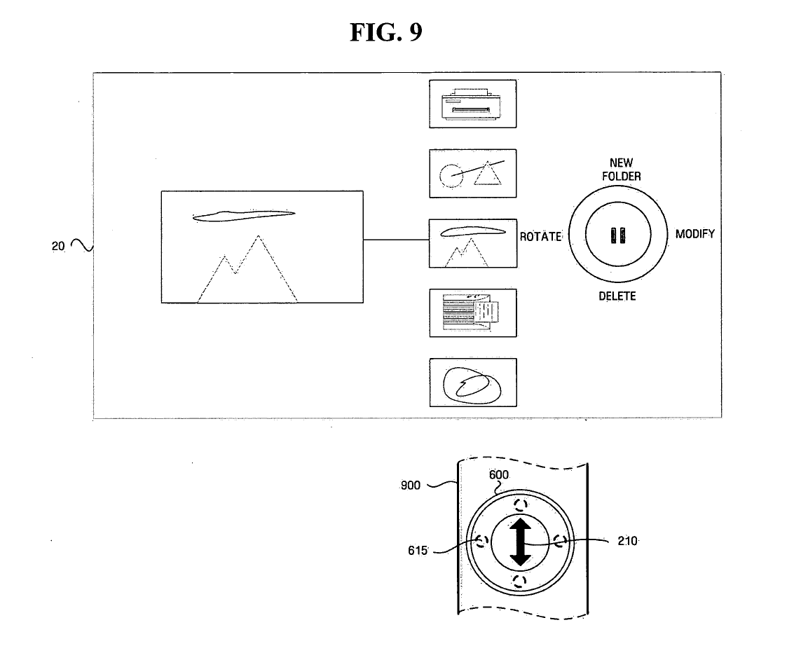

FIG. 9 is a view showing that a figure menu and a direction menu according to an embodiment of the present invention are separately displayed. An image is shown in the left portion of a display screen 20. Up and down directions of a direction control unit 210 can be controlled by selecting one of arranged images. The user can work on the selected image through the circular control unit 600. The user can rotate the selected image by pressing a position 615.

Meanwhile, the direction control unit 210 is not necessarily implemented with buttons, but may be implemented with a touch panel that senses touch. The up and down directions or left and right directions can be selected according to the direction of touch. In addition, according to the structure of content, an input signal corresponding to only the up and down directions may be generated.

The direction control unit 210 does not necessary take a form including the up, down, left, and right directions, but may take a circular form if the direction of manipulation of the remote control and the direction of control of the screen are the same.

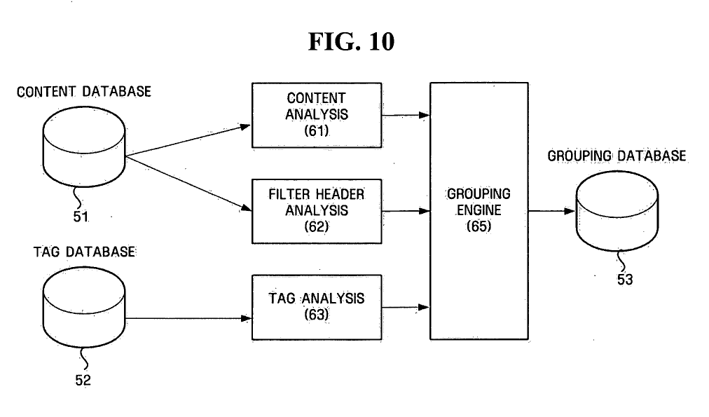

FIG. 10 illustrates arranging of contents of FIG. 4 or 8 to satisfy a UI according to an embodiment of the present invention. Contents can be arranged in various ways, such as based on name or date in FIG. 4. In FIG. 8, broadcasting contents are classified by genre. To display menus as in FIG. 4 or FIG. 8, automatic setting is possible according to the features of the menus and manual setting is possible by a user's input. For example, when the user views contents by storage medium or date in FIG. 4, the user can arrange the contents using a processor embedded in a DTV. However, to arrange images by theme, character, or place, the images should be analyzed and user's direct intervention may be required. After such a process, tag information may be added to display menus.

First, in a content database 51 storing contents, information about contents and information about files storing contents are analyzed. In content analysis 61, image information constituting the contents may be processed. For example, the contents may be arranged by image information of a specific character for character-based arrangement. In file header analysis 62, pre-processing is performed for content arrangement by date on which files are created or information about folders in which files are stored. In content analysis 61, the user may directly create a specific category and dispose corresponding content in the created category.

Meanwhile, a tag database 52 provides information indicating which category contents correspond to or information required for arranging contents according to classification. A tag generated by the tag database 52 provides information indicating which contents are grouped through tag analysis 63. Data passing through content analysis 61, filter header analysis 62, and tag analysis 63 is stored in a grouping database 53 by a grouping engine 65. The grouping database 53 provides information indicating which function is provided to which menu and which content is related to which menu. Contents include not only contents stored in a storage medium but also contents available from outside sources through a network, e.g., broadcasting contents. In addition, the grouping database 53 also includes information about arrangement of menus and arrangement of items of a figure menu.

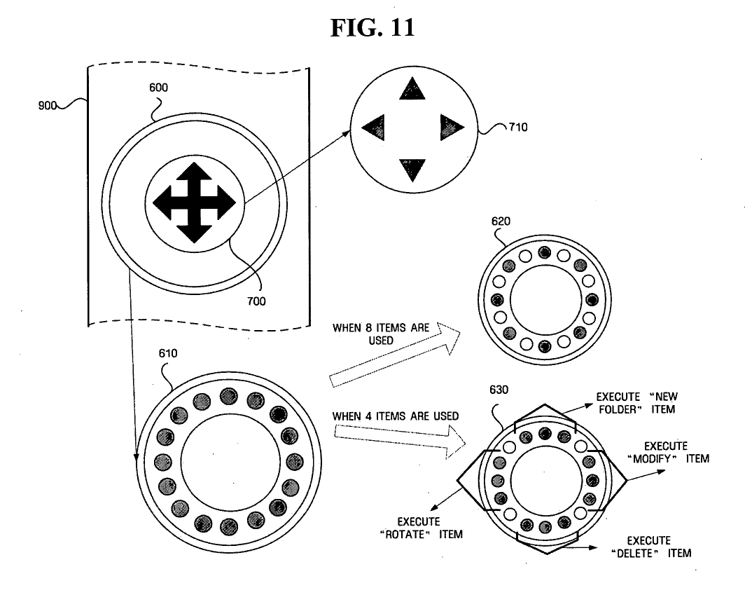

FIG. 11 illustrates a remote control according to an embodiment of the present invention. The figure control unit 600 of the remote control 900 can determine which position is pressed by the user. Since the number of menus that can be arranged in the figure control unit 600 may vary, it is advantageous that the position at which the figure control unit 600 is touched be determined through a touch panel instead of fixing 4 or 8 buttons.

When the remote control unit 610 includes buttons, the maximum number of buttons may be assigned and combined. A total of 16 buttons are included in the remote control unit 610. If 8 items of the circular menu can be selected as in FIG. 4, only some of the buttons of the remote control unit 610 are assigned to select the 8 items as in 620. Only black buttons transmit signals required for executing the items of the circular menu and white buttons may not execute the items of the circular menu. On the other hand, buttons in a specific portion may be grouped for a single item. In FIG. 9, the circular menu includes a total of 4 items (“new folder”, “rotate”, “modify”, and “delete”). 12 buttons among a total of 16 buttons of the remote control unit 630 are assigned for menu selection. Since 3 buttons constitute a single item, the user can execute the “new folder” item by selecting one of the 3 buttons assigned to the “new folder” item.

Meanwhile, a direction control unit 700 may be implemented with up/down/left/right buttons or a touch panel. In addition, a direction control unit 710 implemented with up/down/left/right buttons is similar to that implemented in a general remote control.

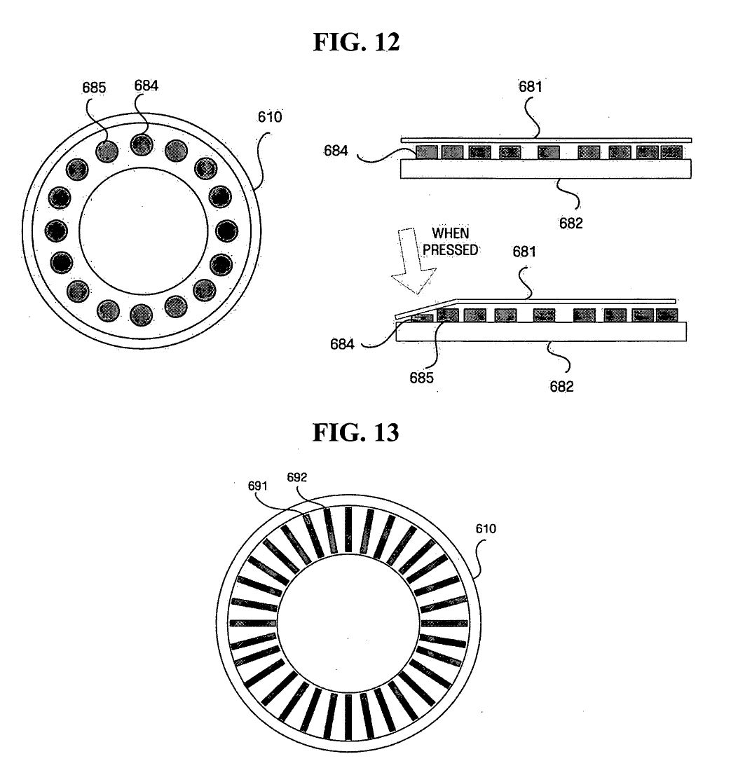

FIG. 12 illustrates a remote control including a circular control unit having buttons according to another embodiment of the present invention. When a circular control unit is implemented with buttons in FIG. 11, information indicating that each button is associated with which menu to support various menu item configurations (4 items, 8 items, and 16 items). Since each button occupies a predetermined position on a circle, information about a predetermined position on the circle can be transmitted when a corresponding button is pressed. Alternatively, a remote control may transmit an identifier of a corresponding button and an interface output device may calculate position information corresponding to the received identifier. When the user presses a position 681 in the remote control, the pressed position 681 presses a button 684 toward base 682 and position information or identifier information of the button 684 is transmitted to a display device. Thus, it can be determined which menu is executed according to a currently displayed menu item configuration.

When at least two buttons are pressed, a corresponding menu can be executed if the at least two buttons are matched to one of currently displayed menu items. In FIG. 12, when two buttons 684 and 685 are pressed at the same time, if four items of the circular menu are used as in 630 of FIG. 11, the “new folder” item can be executed even when the two buttons 684 and 685 are pressed.

FIG. 13 illustrates a touch panel according to an embodiment of the present invention.

A touch panel senses an external touch and converts the sensed external touch into an electric signal. In the present embodiment, the touch panel is mounted in an input device such as a remote control to generate an input signal suitable for various menu item configurations. There are various types of touch panels, such as a capacitance-type and a resistance-type. A plurality of sensors 691 and 692 is attached to a circular menu 610 implemented with a touch panel in FIG. 13. Each of the sensors is assigned an identification number and generates a predetermined electric signal when the user touches the sensor. As a result, the position or direction of touch can be determined to perform a function of a corresponding item.

If the user touches the sensor 691, charged electricity may transfer. At this time, the position or direction of user's touch can be determined based on from which sensor electricity transfers.

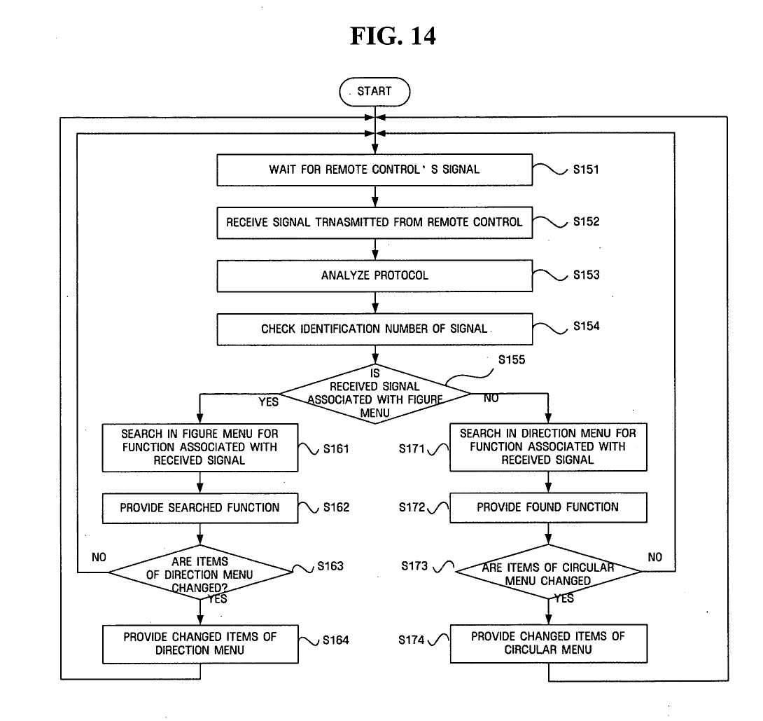

FIG. 14 is a flowchart illustrating a method used by a display device to provide a function corresponding to an input signal of a remote control according to an embodiment of the present invention.

A display device waits for a signal transmitted from a remote control in operation S151. When a user presses a specific button or a specific position of a touch panel through a remote control, a signal is generated and the display device receives the generated signal in operation S152. The received signal is analyzed according to a predetermined protocol in operation S153. The identification number of the signal is checked in operation S154. When a signal is generated through a button, the identification number may be the identification number of the button. When the signal is generated through the touch panel, the identification number may include information about the pressed position. It is determined whether the checked signal is associated with a figure menu, i.e., is generated by a circular control unit, in operation S155. If the checked signal is associated with the figure menu, a function corresponding to the checked signal is searched in currently output figure menu items in operation S161. For example, when information about the specific position is received, it is determined which item corresponds to the specific position or which function is provided by the item. When the identification number of the button is received, it can be determined the button executes an item at which position. The determined function is provided in operation S162. Providing the determined function means providing a function of arranging contents by, for example, date when the button 606 is pressed in FIG. 4. In operation S163, it is checked whether items of a direction menu are also changed due to provision of the determined function in operation S162. A change in items of the direction menu may be made, for example, when the user selects the “event-based” item in FIG. 6. If items of the direction menu are not changed, the display device waits for receipt of a signal from the remote control in operation S151. When items of the direction menu are changed, the changed items of the direction menu are provided in operation S164. After the items of the direction menu are changed, the display device waits for receipt of a signal from the remote control in operation S151.

If the received signal is associated with the direction menu, instead of the figure menu in operation S155, functions corresponding to the direction menu are provided. First, functions associated with the received signal are searched in currently output direction menu items in operation S171. For example, when information about a specific direction is received, it is determined which item corresponds to the specific direction or the item provides which function. When the identification number of a button is received, it can be determined the button executes which direction item. The determined function is provided in operation S172. Here, providing the determined function means configuring menu items as in FIGS. 11 and 12 when a right direction key or a left direction key is pressed in FIG. 6. In operation S173, it is checked whether items of the figure menu (circular menu) are also changed due to provision of the determined function in operation S172. A change in items of the figure menu may be made, for example, according to whether content in the center is an image or a moving picture in FIG. 7. If items of the figure menu are not changed, the display device waits for receipt of a signal from the remote control in operation S151. When items of the figure menu are changed, the changed items of the figure menu are provided in operation S174. After the items of the figure menu are changed, the display device waits for receipt of a signal from the remote control in operation S151.

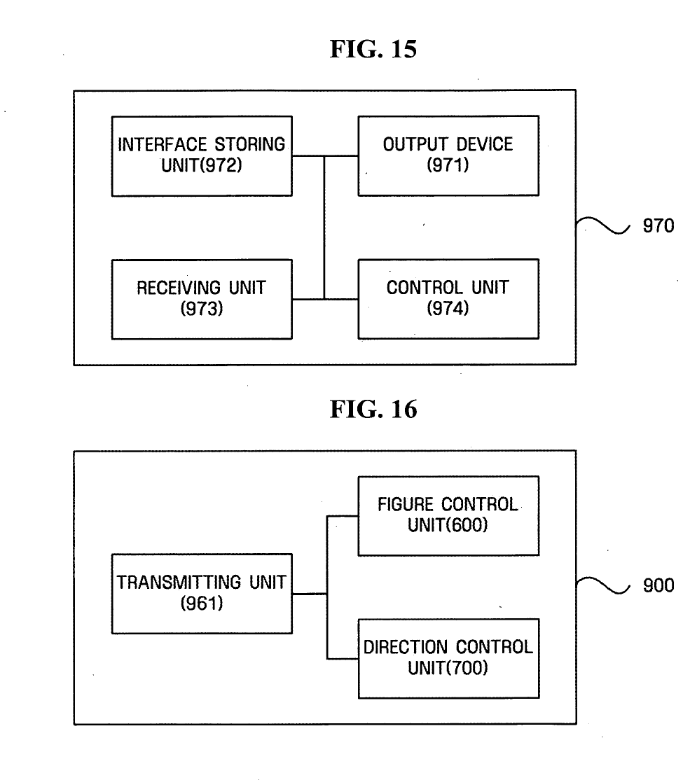

FIG. 15 is a block diagram of a UI output device according to an embodiment of the present invention. Referring to FIG. 15, an interface output device 970 outputs an interface and includes a system such as a DTV in which control and output are implemented. The interface output device 970 also includes a system, such as a DVD reproducing apparatus and a personal video recorder (PVR), which outputs an interface to another device and processes interface information required for output and an input signal. An output unit 971 outputs an interface to a display device according to menu item configurations stored in an interface storing unit 972 and activates or deactivates a specific menu item according to an input signal received by a receiving unit 973.

The interface storing unit 972 stores menus of the interface and information about positions of the menus. In particular, items output in the figure menu are arranged on the circumference of a figure. Since a position in which each item is output is important, position information may also be stored. Position information included in the received signal is compared with the stored position information to provide information for determining which menu item corresponds to the signal received by the receiving unit 973.

The receiving unit 973 receives a signal transmitted from an external input device such as a remote control and transmits the signal to a control unit 974. The signal transmitted from the external input device includes identification information indicating which button is pressed or position information indicating which position of a touch panel is selected.

The control unit 974 determines which menu item is executed by the input signal received by the receiving unit 973 by information about the item currently output by the output unit 971 and performs a function corresponding to the menu item.

When the receiving unit 973 receives identification information of a button, the control unit 974 determines which menu item corresponds to the button through the interface storing unit 972 and executes a function corresponding to the determined menu item. When the receiving unit 973 receives position information, the control unit 974 determines which menu item corresponds to the position through the interface storing unit 972 and executes a function corresponding to the determined menu item. When the external input device is implemented with a touch panel, the receiving unit 973 may receive a plurality of position information. In this case, menu items corresponding to the plurality of position information are checked and a largest number of menu items may be selected. For example, when the received position information is A, B, and C and menu items corresponding to the received position information are a, b, and c, the menu item b is executed because position B is middle of A and B. Such a determination may be performed by a remote control. In the case of a touch panel, information about one of sensors may be transmitted.

FIG. 16 is a block diagram of a remote control according to an embodiment of the present invention. The remote control 900 includes a figure control unit 600, a direction control unit 700, and a transmitting unit 961. The figure control unit 600 is implemented with a touch panel or buttons as mentioned above and receives menu item position information according to a user's input. The direction control unit 700 provides a function of selecting an item in up and down directions or left and right directions. The transmitting unit 961 transmits information input from the figure control unit 600 or the direction control unit 700 to an output device. The input information may be an identifier of a pressed button when the figure control unit 600 is implemented with buttons. The input information may be information indicating which position is touched when the figure control unit 600 is implemented with a touch panel.

When the user presses or touches a specific position of the figure control unit 600, the transmitting unit 961 transmits position information to an output device and the output device executes a menu item of the figure menu of the interface, corresponding to received position information.

According to the above-described embodiments of the present invention, a user can select a menu item in a UI displayed on a screen, which has the same position or direction as a signal transmitted from a remote control, thereby providing intuitive use and ease of use.

According to the above-described embodiments of the present invention, many inputs or screen conversions are not required for selection of a specific function, thereby enabling rapid manipulation with respect to a digital device.

According to the above-described embodiments of the present invention, the user can easily select a menu item on the screen by selecting a position on the remote control which is the same as the position of the menu item on the screen.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for providing a user interface that enables a user to select a menu having a position or direction corresponding to a position selected by a remote control, the apparatus comprising:
an interface storing unit which stores items of menus and information about functions provided by the menus;
an output unit which outputs items of a first menu stored in the interface storing unit on a circumference of a figure;
a receiving unit which receives an input signal from the remote control; and
a control unit which, when the input signal received by the receiving unit includes a position selected by the remote control, selects an item of the first menu located at a position of the figure corresponding to the position selected by the remote control and executes a function corresponding to the selected item of the first menu.

2. The apparatus of claim 1, wherein the output unit outputs items of a second menu.

3. The apparatus of claim 1, wherein functions provided by the items of the first menu comprise a function of outputting items of a second menu.

4. The apparatus of claim 1, wherein the output unit outputs items of a second menu, changes the items of the first menu, and outputs the changed items on the circumference of the figure when some of the items of the second menu are selected.

5. The apparatus of claim 4, wherein the output unit outputs the items of the first menu before being changed to the circumference of the figure when selection of the items of the second menu is canceled.

6. The apparatus of claim 1, wherein, when the received input signal contains information about at least two predetermined positions, the control unit selects one of the two predetermined positions.

7. The apparatus of claim of claim 1, wherein, when the items of the first menu provide a function for selecting or manipulating contents, a second menu comprising contents or a list of contents to be selected or manipulated by the first menu is provided.

8. A remote control comprising:
a figure control unit which receives menu position information;
a direction control unit which receives up and down or right and left direction information; and
a transmitting unit which transmits the received menu position information and direction information to an output device,
wherein the menu position information indicates a position whose input is sensed by the figure control unit, and the transmitting unit transmits the received menu position information and executes a menu corresponding to the menu position information of an interface output on the output device.

9. The remote control of claim 8, wherein the figure control unit comprises a touch panel.

10. The remote control of claim 8, wherein the figure control unit comprises a plurality of buttons and senses a pressure applied to the buttons to generate the menu position information.

11. The remote control of claim 8, wherein, when information about at least two positions are input, the transmitting unit outputs information indicated by buttons of the figure control unit to the output device.

12. A method of providing a user interface that enables a user to select menu having the same position or direction as a position selected by a remote control, the method comprising:
outputting items of a first menu on a circumference of a figure;
receiving an input signal from the remote control; and
selecting an item of the first menu at a position of the figure corresponding to the position selected by the remote control and executing a function provided by the selected item of the first menu, when the input signal contains a position selected by the remote control.

13. The method of claim 12, further comprising outputting items of a second menu after the outputting of the items of the first menu.

14. The method of claim 12, wherein functions provided by the items of the first menu include a function of outputting items of a second menu.

15. The method of claim 12, further comprising:
outputting items of a second menu; and
changing items of the first menu and outputting the changed items on the circumference of the figure when some of the items of the second menu are selected.

16. The method of claim 15, further comprising outputting the items of the first menu before changing the items of the first menu to the circumference of the figure when selection of the items of the second menu is canceled.

17. The method of claim 12, wherein one of the two predetermined positions is selected when the received input signal includes information about at least two predetermined positions.

18. The method of claim 12, wherein the second menu includes contents or a list of contents to be selected or manipulated by the first menu when the items of the first menu provide a function for selecting or manipulating contents.

19. A computer-readable storage medium encoded with processing instructions for causing a processor to execute a method of providing a user interface that enables a user to select menu having the same position or direction as a position selected by a remote control, the method comprising:
outputting items of a first menu on a circumference of a figure;
receiving an input signal from the remote control; and
selecting an item of the first menu at a position of the figure corresponding to the position selected by the remote control and executing a function provided by the selected item of the first menu, when the input signal contains a position selected by the remote control.
